(19) United States
(12) Patent Application Publication
(10) Pub. No.: US 2024/0320549 A1
(43) Pub. Date: Sep. 26, 2024

(54) INFORMATION PROCESSING APPARATUS, INFORMATION PROCESSING METHOD, AND RECORDING MEDIUM

(71) Applicant: KABUSHIKI KAISHA TOSHIBA, Tokyo (JP)

(72) Inventor: Topon PAUL, Kawasaki Kanagawa (JP)

(73) Assignee: KABUSHIKI KAISHA TOSHIBA, Tokyo (JP)

(21) Appl. No.: 18/494,054

(22) Filed: Oct. 25, 2023

(30) Foreign Application Priority Data
Mar. 20, 2023 (JP) 2023-044642

(51) Int. Cl. G06N 20/00

(52) U.S. Cl. CPC G06N 20/00

(57) ABSTRACT

An information processing apparatus comprising processing circuitry, the processing circuitry inputs first learning data including time-series data to a first model and calculate a forecasted value of a target variable that is a forecasting target, calculates a first forecasting residual amount that is a deviation of the forecasted value by using second learning data; and constructs a second model for predicting the first forecasting residual amount by machine learning based on the second learning data and the first forecasting residual amount.

### CROSS REFERENCE TO RELATED APPLICATIONS

This application is based upon and claims the benefit of priority from the prior Japanese Patent Application No. 2023-044642, filed on Mar. 20, 2023, the entire contents of which are incorporated herein by reference.

### FIELD

An embodiment described herein relates to an information processing apparatus, an information processing method, and a recording medium.

### BACKGROUND

Models for performing machine learning (hereinafter, a machine learning model) are utilized in various fields. Since not only time-series data but also control data can be input to the machine learning model, a forecasting accuracy is higher than that of a physical model that cannot handle the control data.

However, in the machine learning model, forecasting performance deteriorates in a case where there is a correlation between explanatory variables or in a case where the explanatory variables contain noise. Moreover, the longer a forecasting period, the larger a forecasting error.

### BRIEF DESCRIPTION OF THE DRAWINGS

FIG. 1 is a block diagram illustrating a schematic configuration of an information processing apparatus according to an embodiment;

FIG. 2 is a diagram illustrating an example of data division of learning data for predicting a dam inflow amount;

FIG. 3 is a diagram illustrating an example of data division of learning data for predicting a wind power generation amount;

FIG. 4 is a diagram illustrating an example in which clustering is performed according to the characteristics of the waveform of time-series data of a target variable and the time-series data is divided into characteristic sections based on the clustering;

FIG. 5 is a diagram illustrating an example of calculating a contribution amount of a physical model for each characteristic section based on a correlation coefficient;

FIG. 6 is a flowchart illustrating a processing procedure of forecasting model learning processing;

FIG. 7 is a flowchart illustrating a processing operation of a forecasting unit 3 that predicts a future state value or an output value of a system, an apparatus, or a device of interest;

FIG. 8 is a diagram for explaining construction of a forecasting model for dam inflow amount forecasting according to a first specific example;

FIG. 9 is a diagram for explaining construction of a forecasting model for wind power generation amount forecasting according to a second specific example;

FIG. 10 is a diagram for explaining construction of a forecasting model for predicting a river flow rate or a river water level according to a third specific example;

FIG. 11 is a diagram illustrating an example of an H-Q curve indicating a relationship between a flow rate and a water level;

FIG. 12 is a diagram for explaining construction of a forecasting model for predicting a river flow rate or a river water level according to a fourth specific example; and

FIG. 13 is a diagram for explaining construction of a forecasting model for weather forecasting according to a fifth specific example.

### DETAILED DESCRIPTION

According to one embodiment, an information processing apparatus comprising processing circuitry, the processing circuitry inputs first learning data including time-series data to a first model and calculate a forecasted value of a target variable that is a forecasting target, calculates a first forecasting residual amount that is a deviation of the forecasted value by using second learning data; and constructs a second model for predicting the first forecasting residual amount by machine learning based on the second learning data and the first forecasting residual amount.

Hereinafter, an embodiment of an information processing apparatus, an information processing method, and a program will be described with reference to the drawings. Although main components of the information processing apparatus will be mainly described below, the information processing apparatus may have components and functions that are not illustrated or described. The following description does not exclude components and functions that are not illustrated or described.

The physical model can calculate a highly reliable forecasting value, but for this purpose, it is necessary to perform accurate system calibration and input accurate parameters to the physical model. In a case where the system calibration or the parameter is inaccurate, or in a case where the forecasting value of the physical model changes over time, a forecasting error increases.

In addition, in the physical model, since external control information (for example, an upstream dam discharge amount or an amount of water used in a power plant) cannot be considered, forecasting reflecting a control operation cannot be performed.

On the other hand, in the machine learning model, a forecasting value can be calculated in consideration of the external control information, and an accurate forecasting value can be calculated by using past data and a current characteristic of a system or a device. However, in the machine learning model, when there is a correlation between input variables or when the input variables include noise, a forecasting performance is degraded.

Therefore, an information processing apparatus according to an embodiment constructs a forecasting model in which a physical model and a machine learning model are fused, and calculates a forecasting value up to a forecasting period by using the forecasting model.

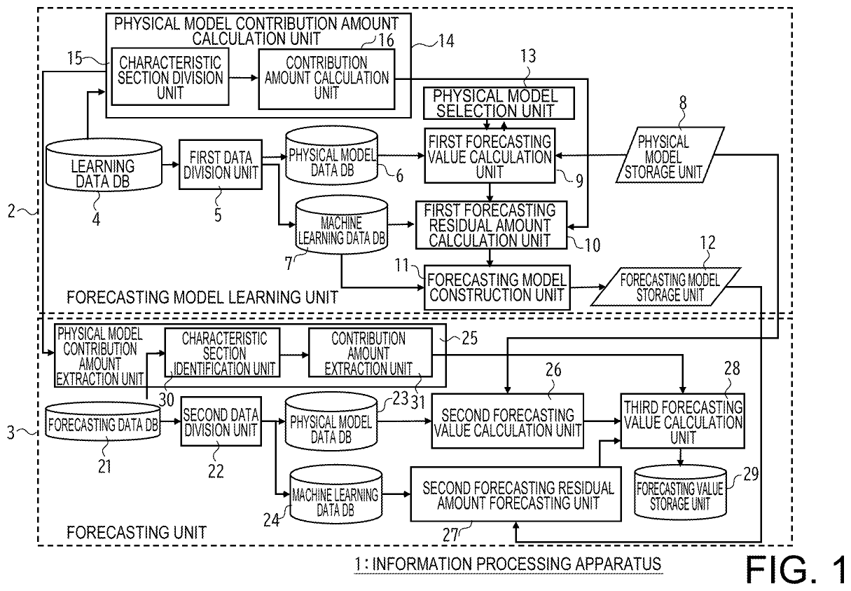

FIG. 1 is a block diagram illustrating a schematic configuration of an information processing apparatus 1 according to an embodiment. The information processing apparatus 1 in FIG. 1 is characterized in that various forecasting targets can be forecasted by using a forecasting model in which a physical model and a machine learning model are fused. As illustrated in FIG. 1, the information processing apparatus 1 according to the embodiment includes a forecasting model learning unit 2 and a forecasting unit 3. The information processing apparatus 1 according to the present embodiment may include, for example, processing circuitry. The processing circuitry executes, for example, at least one processing operation of the forecasting model learning unit 2 or the forecasting unit 3 of FIG. 1.

The forecasting model learning unit 2 constructs a forecasting model in which a physical model and a machine learning model are fused. In the present specification, the physical model may be referred to as a first model, and the forecasting model may be referred to as a second model. In addition, in the present specification, physical model data input to the physical model (first model) may be referred to as first learning data, and machine learning data input to the forecasting model (second model) may be referred to as second learning data.

The forecasting model learning unit 2 includes a learning data DB (database) 4, a first data division unit 5, a physical model data DB 6, a machine learning data DB 7, a physical model storage unit 8, a first forecasting value calculation unit 9, a first forecasting residual amount calculation unit 10, a forecasting model construction unit 11, a forecasting model storage unit 12, and a physical model selection unit 13.

The learning data DB 4 stores learning data. The learning data includes time-series data of a state or an output of a system, an apparatus, or a device of interest, or time-series data of an external factor affecting the system, the apparatus, or the device. The time-series data is, for example, a past measurement value (actual value), a value obtained by simulation, a future forecasting value, or data used in the simulation. All the time-series data in the learning data may be past measurement values (actual values), future forecasting values, values used in simulation, or values obtained by arbitrarily combining these values. The past measurement value may be sensor data.

The learning data DB 4 holds time-series data of a target variable that is a forecasting target and time-series data of an explanatory variable. Among the time-series data, time-series data corresponding to an item of interest of the state or output of the system, the apparatus, or the device is treated as time-series data of the target variable. That is, the time-series data of the target variable is a state value or an output value of the system, the apparatus, or the device of interest. The time-series data of the explanatory variable is time-series data of an internal or external factor that affects the state value or the output value of the system, the apparatus, or the device of interest. A value of the explanatory variable directly or indirectly affects a value of the target variable.

The first data division unit 5 divides the time-series data of the learning data DB 4 into physical model data and machine learning data, and stores the data separately in the physical model data DB 6 or the machine learning data DB 7. For example, the first data division unit 5 sets time-series data necessary for a physical model as the physical model data and sets remaining data as the machine learning data. The physical model data and the machine learning data may be mutually exclusive, or at least some of the data may overlap.

In addition, the first data division unit 5 may select the machine learning data from the learning data by using a correlation coefficient between the time-series data of the target variable and the time-series data of the explanatory variable, may select the machine learning data by using a characteristic selection method, may select the machine learning data by using an information amount method (for example, an Akaike information amount criterion, a Bayesian information amount criterion, and the like), or may select the machine learning data by using a forecasting method. In a case of selecting the machine learning data by using the forecasting method, the time-series data of each explanatory variable and a target variable may be divided into training data and validation data, a temporary forecasting model may be constructed by using the training data, a forecasting error of the validation data may be calculated by using the constructed temporary forecasting model, and the time-series data of some explanatory variables having a smaller forecasting error may be selected based on an ascending order of the forecasting errors. The information processing apparatus 1 in FIG. 1 constructs a forecasting model by using the selected physical model data and machine learning data.

The explanatory variable can also be selected by using combinatorial optimization. For example, when the explanatory variables are {X1, X2, X3}, there are combinatorials of {X1}, {X2}, {X3}, {X1, X2}, {X2, X3}, {X1, X3}, and {X1, X2, X3}, and a temporary forecasting model may be constructed by using data of explanatory variables obtained by combining the combinatorials, and the time-series data of the explanatory variables of a lowest forecasting errors may be used as the machine learning data. The physical model data DB 6 holds an explanatory variable used in the physical model of the target variable or time-series data of the target variable.

The machine learning data DB 7 stores time-series data of a target variable and an explanatory variable used in machine learning. The machine learning data may include physical model data.

In a case where there are a plurality of physical models, the physical model selection unit 13 selects a best physical model according to an evaluation scale. The physical model data is input to each physical model to calculate a forecasting value of the target variable. A forecasting error can be calculated by using a forecasting value and an actual value of the target variable, and the forecasting error can be used as the evaluation scale. As the evaluation scale, a root mean square error (RMSE), a coefficient of determination (R2), a mean absolute error (MAE), a mean absolute percentage error (MAPE), or the like can be used.

The learning data DB 4, the first data division unit 5, the physical model data DB 6, and the machine learning data DB 7 described above are not necessarily essential components for the information processing apparatus 1, and for example, the physical model data and the machine learning data may be input from an outside of the information processing apparatus 1.

The first forecasting value calculation unit 9 inputs the physical model data acquired from the physical model data DB 6 to the physical model to calculate a forecasting value of the target variable by the physical model. The target variable is, for example, a dam inflow amount, a wind power generation amount, a river flow rate, or the like. The forecasting value calculated by the first forecasting value calculation unit 9 may be a forecasting value that directly predicts the target variable or may be a forecasting value that indirectly predicts the target variable.

The physical model to be used differs depending on an application of the information processing apparatus 1 according to the embodiment, and the forecasting value of the target variable may be calculated by using a plurality of physical models in some cases. The physical model may be a calculation formula for calculating a forecasting value of the target variable, or may be configured by a complicated simulator. For example, when a dam inflow amount or a river flow rate is forecasted, a tank model and a snow melting model are used as physical models. When the wind power generation amount is forecasted, a power generation model of a wind turbine is used as a physical model.

The physical model data input to the physical model varies depending on the physical model to be used. For example, when a tank model is used in the dam inflow amount forecasting, a height (L1, L2, L3) of an outflow hole, an outflow coefficient (α1, α2, α3, α4), and a permeation coefficient (β1, β2, β3) are used as the physical model data. In a case of using the snow melting model, digital elevation model data, an air temperature decreasing rate, and an air temperature snow melting rate are used as the physical model data. In the wind power generation amount forecasting, a power generation curve, wind turbine parameters, and topographical information are used as the physical model data.

The first forecasting residual amount calculation unit 10 calculates a forecasting residual amount (hereinafter, referred to as a first forecasting residual amount) of the physical model. The first forecasting residual amount calculation unit 10 calculates a first forecasting residual amount of the physical model by subtracting the forecasting value of the target variable calculated by the first forecasting value calculation unit 9 from the target variable. More specifically, the first forecasting residual amount calculation unit 10 extracts time-series data of the target variable from the machine learning data, and calculates the first forecasting residual amount of the physical model by using the extracted time-series data of the target variable, the forecasting value of the target variable calculated by the first forecasting value calculation unit 9, and a contribution amount of the physical model for each characteristic section to be described later.

Based on the machine learning data and the first forecasting residual amount of the physical model calculated by the first forecasting residual amount calculation unit 10, the forecasting model construction unit 11 constructs a forecasting model for predicting the first forecasting residual amount of the physical model from the machine learning data by machine learning.

The forecasting model construction unit 11 constructs a forecasting model for predicting the first forecasting residual amount of the physical model calculated by the first forecasting residual amount calculation unit 10 by machine learning by using the machine learning data.

As the forecasting model, for example, a regression model, a model based on deep learning, a model based on graph deep learning, or the like can be applied. As the regression model, for example, linear regression, ridge regression, LASSO, regression tree, support vector regression, gradient boosting regression, random forest regression, or the like can be applied. As the model based on the deep learning, for example, long short term memory (LSTM), recurrent neural network (RNN), gated recurrent unit (GRU), convolutional neural network (CNN), or the like can be applied. For example, a graph neural network (GNN) which is a graph deep learning algorithm can be applied as the model based on the graph deep learning. In a case where the forecasting model is a classification problem, logistic regression, a support vector machine (SVM), a decision tree, CNN, an autoencoder (self-encoder), a neural network, or the like can be applied as the machine learning.

The forecasting model storage unit 12 stores the forecasting model constructed by the forecasting model construction unit 11.

In addition, the forecasting model learning unit 2 may include a physical model contribution amount calculation unit 14. The physical model contribution amount calculation unit 14 includes a characteristic section division unit 15 and a contribution amount calculation unit 16.

The characteristic section division unit 15 divides a forecasting period into a plurality of characteristic sections by using a pattern of the time-series data of the target variable. The contribution amount calculation unit 16 calculates a contribution amount of the physical model for each characteristic section. That is, when the physical model selection unit 13 selects two or more physical models, the contribution amount calculation unit 16 calculates a contribution amount of each physical model for each characteristic section. The contribution amount calculation unit 16 may give the contribution amount of each physical model for each characteristic section by knowledge of an expert, may set a correlation coefficient between the forecasting value calculated by each physical model and the time-series data of the target variable, or may set the contribution amount in advance by a user. In addition, the contribution amount of each physical model may be set based on an error between the forecasting value calculated by each physical model and the time-series data of the target variable. For example, an inverse value of a normalized absolute error may be used as the contribution amount of the physical model.

In a case of the dam inflow amount forecasting, an inflow amount flowing into a dam depends on an outflow amount generated from snow melting and a rainfall amount, and the outflow amount output by the tank model, which is a physical model of the dam inflow amount forecasting, and the snow melting model of the snow melting changes depending on a period. Therefore, (0.5, 0.1), (0.2, 0.9), and (0.9, 0.0) can be set as the respective contribution amounts in a snow accumulation period, a snow melting period, and a rainfall period.

Alternatively, a method of automatically calculating the contribution amount of the tank model and the snow melting model, which are physical models for the dam inflow amount forecasting, may be adopted. First, actual rainfall amount data, a snow accumulation amount, an air temperature, and a dam inflow amount are extracted from the learning data for each snow accumulation period, snow melting period, and rainfall period, the actual rainfall amount data is input to the tank model, and the snow accumulation amount and the air temperature are input to the snow melting model to calculate the respective outflow amounts, and the correlation coefficient between the calculated outflow amount and the dam inflow amount in the section is set as the contribution amount of the tank model and the snow melting model.

In the wind power generation amount forecasting, since a power generation amount varies depending on a wind speed, a contribution amount of a power generation model (physical model) of the wind turbine in sections of 5 m/s or less, 5 to 10 m/s, 10 to 15 m/s, 15 to 25 m/s, and 25 m/s or more can be set as follows, for example, according to awareness of the expert.

As an example of the contribution amount of the power generation model (physical model) of the wind turbine, {5 m/s or less is 0.7, 5 to 10 m/s is 0.8, 10 to 15 m/s is 0.9, 15 to 25 m/s is 0.8, and 25 m/s or more is 0.1} can be set.

Alternatively, a method of automatically calculating the contribution amount of the power generation model of the wind turbine may be adopted. First, an observed wind speed of a certain section and an observed power generation amount corresponding thereto are extracted from learning data, and the observed wind speed is input to the power generation model of the wind turbine to calculate a power generation amount. A correlation coefficient between the calculated power generation amount and the observed power generation amount is calculated, and the correlation coefficient is used as the contribution amount of the power generation model (physical model) of the wind turbine of the section. The correlation coefficient may be used as it is as the contribution amount, or may be converted into another scale and used.

The first forecasting residual amount calculation unit 10 extracts the time-series data of the target variable from the machine learning data, and calculates the first forecasting residual amount of the physical model by using the forecasting value calculated by the first forecasting value calculation unit 9 by the physical model and the contribution amount of the physical model for each characteristic section calculated by the physical model contribution amount calculation unit 14. The first forecasting residual amount of the physical model is modeled by using machine learning. The first forecasting residual amount of the physical model is represented by a function of the contribution amount of the physical model for each of the time-series data of the target variable, the forecasting value calculated by the physical model, and the characteristic section.

Forecasting residual amount of physical model=f (time-series data of target variable, forecasted value calculated by physical model, and contribution amount of physical model for each characteristic section)

The time-series data of the explanatory variable may be added to the input parameter of the function. In the example of the dam inflow amount forecasting, the first forecasting residual amount is represented by Formula (1). First forecasting residual amount of physical model=dam inflow amount−cₜ×outflow amount ₜ−cₛ×outflow amount ₛ . . . (1)

Here, cₜ and the outflow amount ₜ are the contribution amount of the tank model and the outflow amount forecasted by tank model, and cₛ and the outflow amount ₛ are the contribution amount of the snow melting model and the outflow amount forecasted by the snow melting model.

In the example of the wind power generation amount forecasting, first forecasting residual amount of physical model=wind turbine power generation amount−cₚ×wind turbine power generation amount ₚ . . . (2)

Here, cₚ and the wind turbine power generation amount ₚ are a contribution amount of the power generation model of the wind turbine and a wind turbine power generation amount.

In this manner, the first forecasting residual amount is calculated based on the target variable and a value obtained by multiplying a contribution amount corresponding to a first forecasting value of each physical model. In a more specific example, the first forecasting residual amount is calculated by subtracting a value obtained by multiplying the contribution amount corresponding to the first forecasting value of each physical model from the target variable.

As illustrated in FIG. 1, the forecasting unit 3 includes a forecasting data DB 21, a second data division unit 22, a physical model data DB 23, a machine learning data DB 24, a physical model contribution amount extraction unit 25, a second forecasting value calculation unit 26, a second forecasting residual amount forecasting unit 27, a third forecasting value calculation unit 28, and a forecasting value storage unit 29. The physical model contribution amount extraction unit 25 includes a characteristic section identification unit 30 and a contribution amount extraction unit 31.

The forecasting unit 3 calculates a forecasting value of a target variable up to a forecasting period by using a forecasting model constructed by the forecasting model learning unit 2.

The forecasting data DB 21 stores forecasting data. The forecasting data includes physical model data including time-series data and machine learning data. The machine learning data may include control data in addition to the time-series data.

The second data division unit 22 divides the forecasting data into physical model data and machine learning data. In the present specification, the physical model data divided by the second data division unit 22 may be referred to as first forecasting data, and the machine learning data divided by the second data division unit 22 may be referred to as second forecasting data. The physical model data (first forecasting data) is stored in the physical model data DB 23, and the machine learning data (second forecasting data) is stored in the machine learning data DB 24.

The forecasting data DB 21, the second data division unit 22, the physical model data DB 6, and the machine learning data DB 7 in the forecasting unit 3 are not essential components of the forecasting unit 3, and can be omitted as necessary.

The second forecasting value calculation unit 26 inputs the physical model data (first forecasting data) to the physical model, and calculates a forecasting value of the target variable by the physical model. The physical model is the same as the physical model used in the forecasting model learning unit 2. The second forecasting value calculation unit 26 may calculate the forecasting value by using two or more physical models selected by the physical model selection unit 13.

The second forecasting residual amount forecasting unit 27 inputs the machine learning data (second forecasting data) to the forecasting model, and calculates a second forecasting residual amount that is a deviation of the forecasting value calculated by the second forecasting value calculation unit 26 by the forecasting model. More specifically, the second forecasting residual amount forecasting unit 27 calculates the second forecasting residual amount that is a deviation between the target variable included in the machine learning data (second forecasting data) and the forecasting value calculated by the second forecasting value calculation unit 26.

The third forecasting value calculation unit 28 calculates a forecasting value of the target variable based on the forecasting value calculated by the second forecasting value calculation unit 26 and the second forecasting residual amount calculated by the second forecasting residual amount forecasting unit 27. The calculated forecasting value is stored in the forecasting value storage unit 29.

The characteristic section identification unit 30 identifies physical model data (first forecasting data) into a plurality of characteristic sections. A criterion for identifying into the plurality of characteristic sections is the same as a criterion for dividing into the plurality of characteristic sections by the characteristic section division unit 15 in the forecasting model learning unit 2.

The contribution amount extraction unit 31 extracts a contribution amount of the physical model for each of the plurality of characteristic sections. The third forecasting value calculation unit 28 calculates the contribution amount of the target variable for each of the two or more physical models based on the contribution amount of the first model for each characteristic section

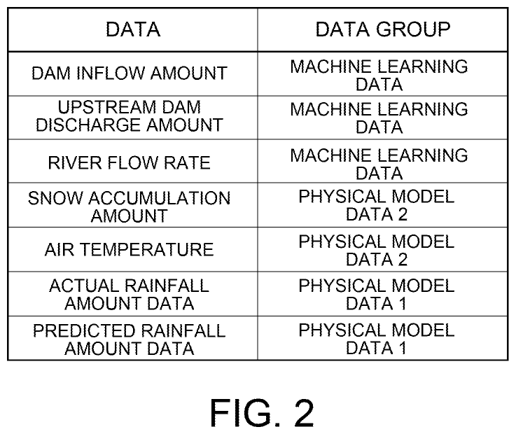

FIG. 2 is a diagram illustrating an example of data division of learning data for predicting a dam inflow amount. The learning data for predicting the dam inflow amount includes a dam inflow amount which is a past measurement value (actual value), an upstream dam discharge amount, a river flow rate, a snow accumulation amount, an air temperature, actual rainfall amount data, and forecasted rainfall amount data which is a future forecasting value. Here, the dam inflow amount is a target variable, and the upstream dam discharge amount, the river flow rate, the snow accumulation amount, the air temperature, the actual rainfall amount data, and the forecasted rainfall amount data are explanatory variables. In addition, the dam inflow amount, the upstream dam discharge amount, the river flow rate, the snow accumulation amount, and the air temperature are values measured by a sensor. The actual rainfall amount data is rain gauge data installed at an observation point or radar analysis rainfall amount data.

In FIG. 2, the snow accumulation amount, the air temperature, the actual rainfall amount data, and the forecasted rainfall amount data are physical model data for the dam inflow amount forecasting.

In FIG. 2, {dam inflow amount, upstream dam discharge amount, river flow rate} or {snow accumulation amount, air temperature, actual rainfall amount data, forecasted rainfall amount data} added thereto, can be used as the machine learning data for the dam inflow amount forecasting.

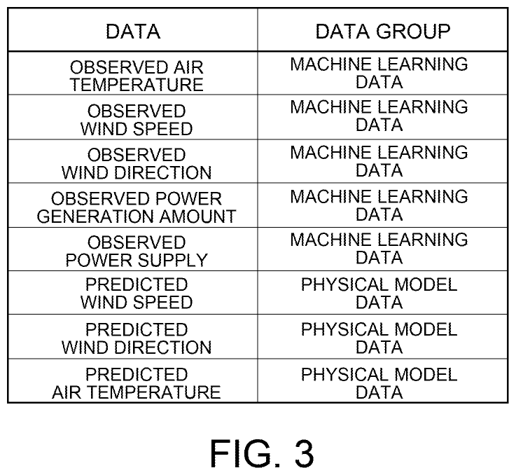

FIG. 3 is a diagram illustrating an example of data division of learning data for predicting a wind power generation amount. The learning data for predicting the wind power generation amount includes an observed air temperature, an observed wind speed, an observed wind direction, an observed power generation amount, and an observed power supply which are past measurement values (actual values), and a forecasted wind speed, a forecasted wind direction, and a forecasted air temperature which are future forecasting values. Here, the power generation amount is a target variable, a value measured by the sensor is an observed power generation amount, and a forecasting value is a forecasted power generation amount. The observed air temperature, the observed wind speed, the observed wind direction, the observed power supply, the forecasted wind speed, the forecasted wind direction, and the forecasted air temperature are explanatory variables. The observed air temperature, the observed wind speed, the observed wind direction, the observed power generation amount, and the observed power supply are values measured by the sensor.

In FIG. 3, the forecasted wind speed, the forecasted wind direction, and the forecasted air temperature are physical model data for performing the wind power generation amount forecasting. In FIG. 3, {observed air temperature, observed wind speed, observed wind direction, observed power generation amount, observed power supply} or {forecasted wind speed, forecasted wind direction, forecasted air temperature} added thereto, can be used as the machine learning data for performing the wind power generation amount forecasting.

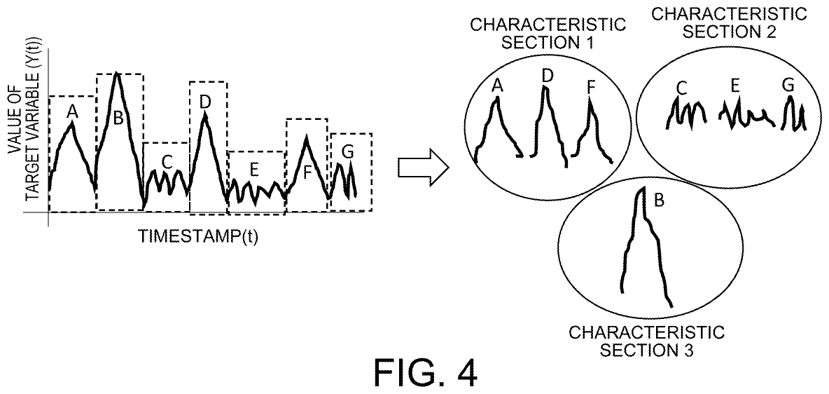

FIG. 4 is a diagram illustrating an example in which clustering is performed according to a characteristic of a shape of time-series data of a target variable and the time-series data is divided into characteristic sections based on the clustering. This example illustrates an example in which the time-series data of the target variable is divided into sections of A, B, C, D, E, F, and G in a time direction and clustering is performed, and the time-series data is divided into three characteristic sections 1, 2, and 3.

The time-series data of the target variable is divided by a sliding window to generate a plurality of samples of the time-series data, and clustering is performed based on each sample. A k-means method, DBA, or the like can be used as a clustering method of the time-series data. On the other hand, the time-series data of the target variable is divided by the sliding window, a statistical value of each window is calculated, and the time-series data can be divided into several characteristic sections based on the clustering of the statistical value.

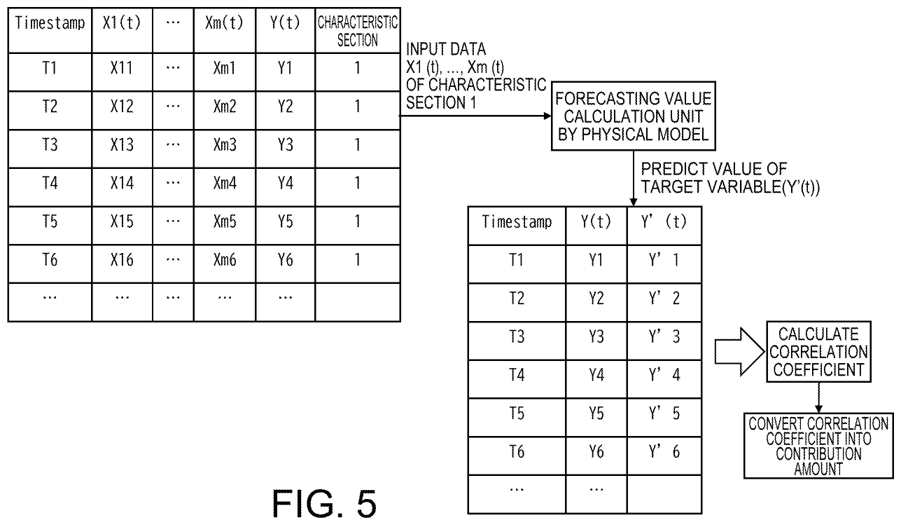

FIG. 5 is a diagram illustrating an example of calculating a contribution amount of a physical model for each characteristic section based on a correlation coefficient. Here, first, learning data of a certain characteristic section is extracted from the learning data, and physical model data of the extracted learning data is input to the first forecasting value calculation unit 9 by the physical model to predict a value (Y′(t)) of the target variable. Thereafter, a correlation coefficient between a value Y(t) of the target variable and the forecasting value Y′(t) calculated by the physical model is calculated, and the correlation coefficient is converted into a contribution amount of the physical model. As a conversion method, normalization of a correlation coefficient can be used. In addition, instead of the correlation coefficient, an error between the value Y(t) of the target variable and the forecasting value Y′(t) calculated by the physical model can be calculated, and an inverse value of an absolute value of the error can be used as the contribution amount of the physical model for each characteristic section.

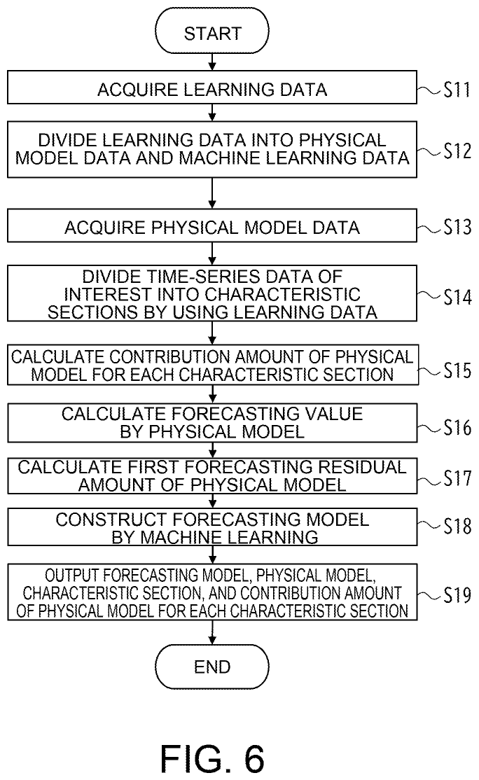

FIG. 6 is a flowchart illustrating a processing procedure of forecasting model learning processing. First, the first data division unit 5 acquires learning data from the learning data DB 4 (step S11), divides the learning data into physical model data and machine learning data, and stores the divided data in the physical model data DB 6 and the machine learning data DB 7 (step S12).

Next, the first forecasting value calculation unit 9 acquires the physical model data from the physical model data DB 17 (step S13). The characteristic section division unit 15 acquires the learning data from the learning data DB 4, and divides time-series data of interest into characteristic sections by using the learning data (step S14).

The contribution amount calculation unit 16 calculates a contribution amount of the physical model for each characteristic section divided by the characteristic section division unit 15 (step S15). The first forecasting value calculation unit 9 inputs the physical model data to the physical model and calculates a forecasted value by the physical model (step S16).

The first forecasting residual amount calculation unit 10 extracts time-series data of a target variable from the machine learning data DB 7, and calculates a first forecasting residual amount of the physical model based on the forecasting value calculated by the first forecasting value calculation unit 9 based on the physical model and the contribution amount of the physical model for each characteristic section calculated by the contribution amount calculation unit 16 (step S17).

The forecasting model construction unit 11 constructs a forecasting model of the first forecasting residual amount of the physical model by machine learning (step S18). The forecasting model constructed by the forecasting model construction unit 11 is stored in the forecasting model storage unit 12. The forecasting model learning unit 2 outputs the constructed forecasting model, the physical model, the characteristic section, and the contribution amount of the physical model for each characteristic section (step S19). As described above, the processing of the forecasting model learning unit 2 ends.

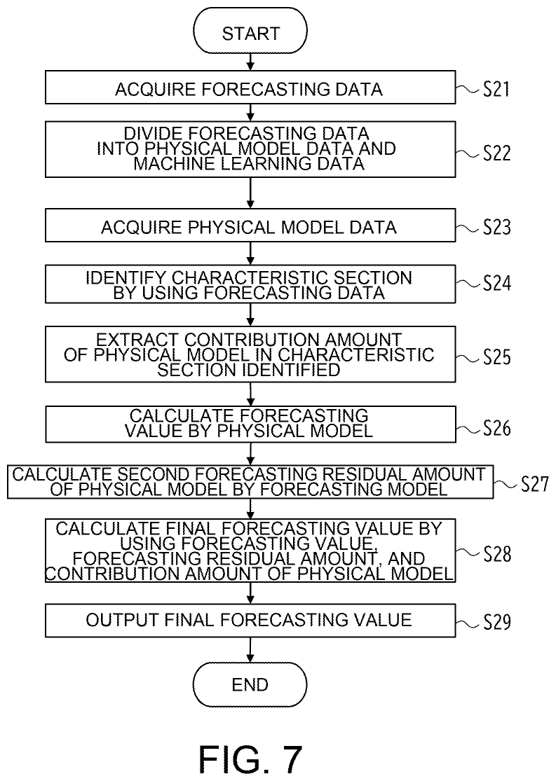

FIG. 7 is a flowchart illustrating a processing operation of the forecasting unit 3 that predicts a future state value or an output value of a system, an apparatus, or a device of interest. First, the second data division unit 22 acquires forecasting data from the forecasting data DB 21 (step S21), divides the forecasting data into physical model data and machine learning data, and stores the data in the physical model data DB 23 and the machine learning data DB 24 (step S22).

Next, the second forecasting value calculation unit 26 acquires physical model data from the physical model data DB 17 (step S23). Next, the characteristic section identification unit 30 acquires forecasting data from the forecasting data DB 21, and identifies a characteristic section by using the forecasting data (step S24).

Next, the contribution amount extraction unit 31 extracts a contribution amount of the physical model in the characteristic section identified by the characteristic section identification unit (step S25). The second forecasting value calculation unit 26 inputs the physical model data (first forecasting data) to the physical model, and calculates a forecasting value by the physical model (step S26).

The second forecasting residual amount forecasting unit 27 calculates a second forecasting residual amount of the physical model by the forecasting model by using the machine learning data (second forecasting data) (step S27). The third forecasting value calculation unit 28 calculates a final forecasting value of the target variable by using the forecasted value calculated by the second forecasting value calculation unit 26 by the physical model, the second forecasting residual amount of the physical model calculated by the second forecasting residual amount forecasting unit 27 of the physical model by the forecasting model, and the contribution amount extracted by the contribution amount extraction unit 31 of the physical model (step S28). The calculated forecasting value is stored in the forecasting value storage unit 29 (step S29).

In step S28, the third forecasting value calculation unit 28 calculates a final forecasting value based on Formula (3) by using the forecasting value calculated by the second forecasting value calculation unit 26 by the physical model, the forecasting residual amount of the physical model calculated by the second forecasting residual amount forecasting unit 27, and the contribution amount extracted by the contribution amount extraction unit 31, and outputs the final forecasting value to the forecasting value storage unit 29.

Final forecasting value=f (forecasting value calculated by physical model, forecasting residual amount of physical model calculated by forecasting model, contribution amount) (3)

When the second forecasting residual amount forecasting unit 27 uses time-series data of an explanatory variable when calculating the forecasting residual amount of the physical model, the explanatory variable is an argument of the function f of Formula (3).

For example, when predicting the dam inflow amount, the third forecasting value calculation unit 28 calculates a final forecasting value based on Formula (4).

Dam inflow amount forecasting value=forecasting residual amount of physical model+cₜ×outflow amount+cₛ×outflow amount ₛ (4)

Here, cₜ and the outflow amount ₛ are a contribution amount of the tank model and an outflow amount by the tank model, and cₛ and the outflow amount ₛ are the contribution amount of the snow melting model and the outflow amount by the snow melting model.

For example, in a case of predicting the wind power generation amount, the third forecasting value calculation unit 28 predicts a final wind power generation amount based on Formula (5).

Wind power generation amount forecasting value=forecasting residual amount of physical model+cₚ×wind turbine power generation amount ₚ (5)

Here, cₚ and the wind turbine power generation amount ₚ are a contribution amount of the power generation model of the wind turbine and a wind turbine power generation amount.

### First Specific Example

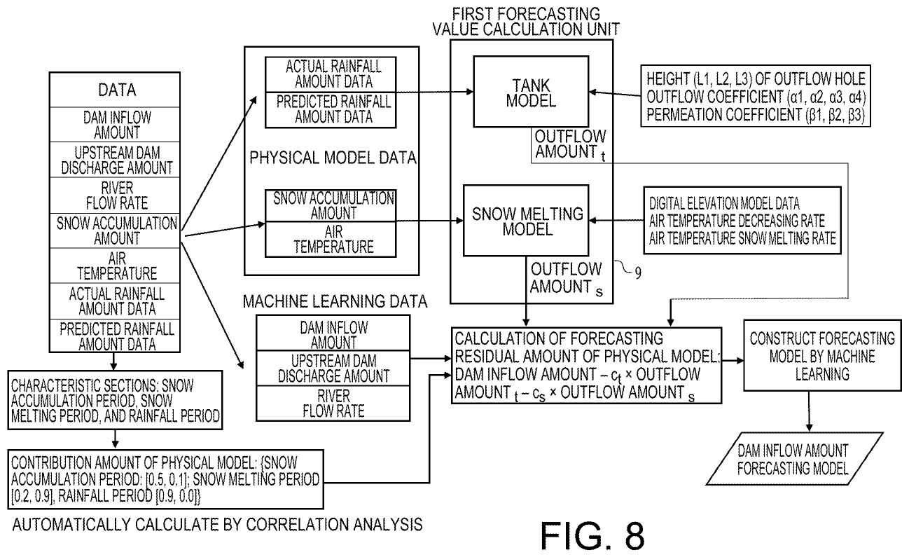

FIG. 8 is a diagram for explaining construction of a forecasting model for dam inflow amount forecasting according to a first specific example. In the first specific example, learning data includes a dam inflow amount, an upstream dam discharge amount, a river flow rate, a snow accumulation amount, an air temperature, actual rainfall amount data, and forecasted rainfall amount data.

The first data division unit 5 divides the snow accumulation amount, the air temperature, the actual rainfall amount data, and the forecasted rainfall amount data of the learning data into physical model data, and divides the dam inflow amount, the upstream dam discharge amount, and the river flow rate into machine learning data. In addition, a tank model and a snow melting model are used as the physical model. Among the physical model data, the actual rainfall amount data and the forecasted rainfall amount data are input to the tank model, and the snow accumulation amount and the air temperature are input to the snow melting model.

The characteristic section division unit 15 divides a forecasting period into a snow accumulation period, a snow melting period, and a rainfall period, and outputs a mapping table {December 1 to March 15: snow accumulation period, March 16 to May 31: snow melting period, June 1 to November 30: rainfall period} of the characteristic sections.

The contribution amount calculation unit 16 outputs a mapping table {snow accumulation period: [0.5, 0.1]; snow melting period: [0.2, 0.9], rainfall period: [0.9, 0.0]} of the characteristic sections of the contribution amount for each period. Here, the contribution amount [a, b] is a contribution amount a of the tank model and a contribution amount b of the snow melting model. The physical model data of the tank model includes a height (L1, L2, L3) of an outflow hole, an outflow coefficient (α1, α2, α3, α4), and a permeation coefficient (β1, β2, β3). The physical model data of the snow melting model is digital elevation model data, an air temperature decreasing rate, and an air temperature snow melting rate.

The tank model and the snow melting model calculate respective outflow amounts. The first forecasting residual amount calculation unit 10 calculates a forecasting residual amount of the physical model as indicated in Formula (6). Forecasting residual amount of physical model=dam inflow amount−cₜ×outflow amount ₜ−cₛ×outflow amount ₛ . . . (6)

Here, cₜ and the outflow amount ₜ are a contribution amount of the tank model and an outflow amount by the tank model, and cₛ and the outflow amount ₛ are a contribution amount of the snow melting model and an outflow amount by snow melting model.

Thereafter, the forecasting model construction unit 11 constructs a forecasting model of the forecasting residual amount of the physical model by machine learning, stores the forecasting model in the forecasting model storage unit 12, and ends the processing.

### Second Specific Example

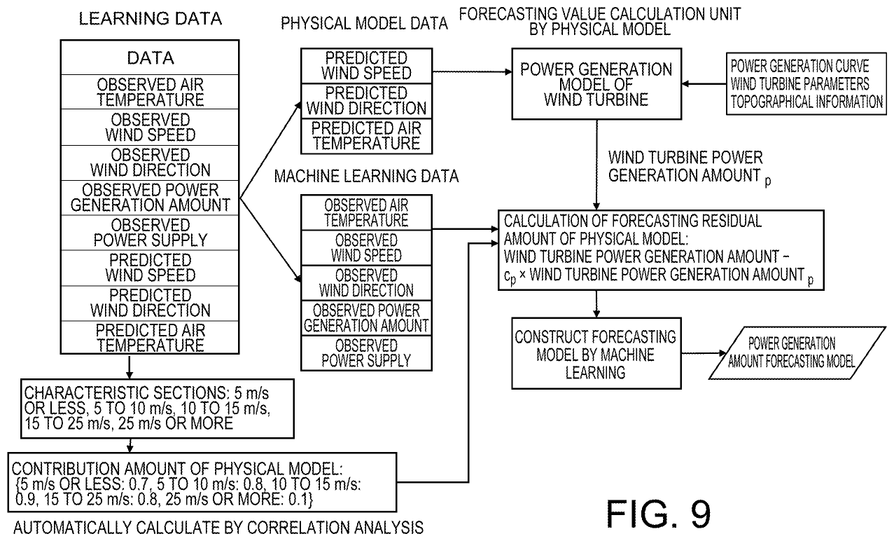

FIG. 9 is a diagram for explaining construction of a forecasting model for wind power generation amount forecasting according to a second specific example. In the second specific example, learning data includes an observed air temperature, an observed wind speed, an observed wind direction, an observed power generation amount, an observed power supply, a forecasted wind speed, a forecasted wind direction, and a forecasted air temperature. The first data division unit 5 divides the forecasted wind speed, the forecasted wind direction, and the forecasted air temperature of the learning data into physical model data, and divides the observed air temperature, the observed wind speed, the observed wind direction, the observed power generation amount, and the observed power supply into machine learning data. A power generation curve is used as the physical model. The characteristic section division unit 15 divides a forecasting period into characteristic sections of {5 m/s or less, 5 to 10 m/s, 10 to 15 m/s, 15 to 25 m/s, 25 m/s or more}. For each characteristic section, the contribution amount calculation unit 16 of the physical model outputs a mapping table of characteristic sections of the contribution amount for each wind speed: {5 m/s or less: 0.7, 5 to 10 m/s: 0.8, 10 to 15 m/s: 0.9, 15 to 25 m/s: 0.8, 25 m/s or more: 0.1}. A power generation curve, wind turbine parameters, and topographical information are used as the physical model data. The power generation model of the wind turbine calculates the power generation amount of the wind turbine with respect to the forecasted wind speed, the forecasted wind direction, and the forecasted air temperature based on the power generation curve, the wind turbine parameters, and the topographical information. The first forecasting residual amount calculation unit 10 calculates a forecasting residual amount of the physical model as follows.

Forecasting residual amount of physical model=wind turbine power generation amount−cₚ×wind turbine power generation amount ₚ (7)

Here, cₚ and the wind turbine power generation amount ₚ are a contribution amount of the power generation model of the wind turbine and a wind turbine power generation amount.

Thereafter, the forecasting model construction unit 11 constructs a forecasting model of the forecasting residual amount of the physical model by machine learning, stores the forecasting model in the forecasting model storage unit 12, and ends the processing.

### Third Specific Example

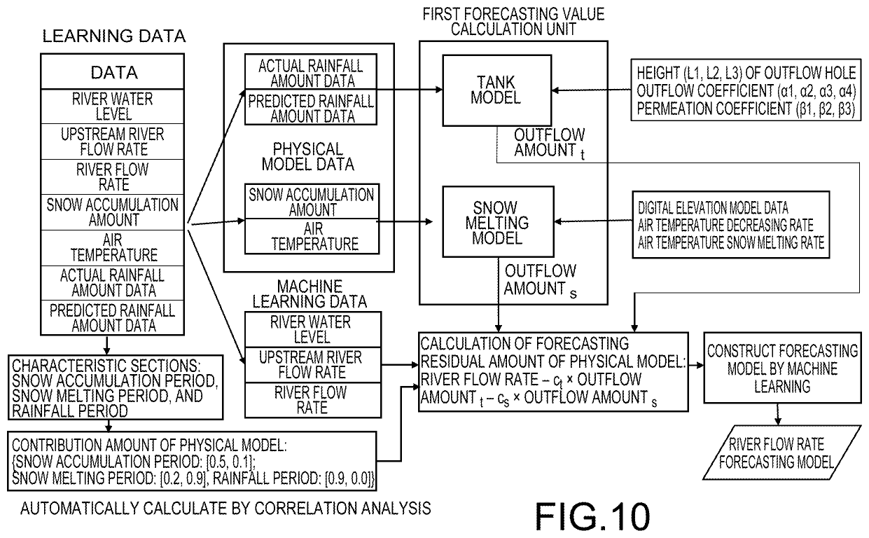

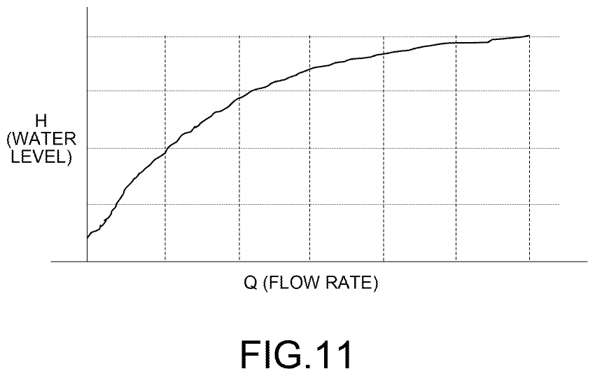

FIG. 10 is a diagram for explaining construction of a forecasting model for predicting a river flow rate or a river water level according to a third specific example, and FIG. 11 is a diagram illustrating an example of an H-Q curve indicating a relationship between a flow rate Q and a water level H.

When a river water level is forecasted, a river flow rate is forecasted, and the river flow rate is converted into the river water level by post-processing. For this purpose, in a target river section, the river flow rate is converted into the river water level by using the H-Q curve related to the water level and the flow rate as illustrated in FIG. 11. Also in a case of dam water level forecasting, the H-Q curve related to the water level and the flow rate can be used.

In an example of river flow rate forecasting, learning data includes a river water level, an upstream river flow rate, a river flow rate, a snow accumulation amount, an air temperature, actual rainfall amount data, and forecasted rainfall amount data. The first data division unit 5 divides the snow accumulation amount, the air temperature, the actual rainfall amount data, and the forecasted rainfall amount data of the learning data into physical model data, and divides the river water level, the upstream river flow rate, and the river flow rate into machine learning data. A tank model and a snow melting model are used as the physical model. Among the physical model data, the actual rainfall amount data and the forecasted rainfall amount data are input to the tank model, and the snow accumulation amount and the air temperature are input to the snow melting model. The characteristic section division unit 15 divides a forecasting period into a snow accumulation period, a snow melting period, and a rainfall period, and outputs a mapping table {December 1 to March 15: snow accumulation period, March 16 to May 31: snow melting period, June 1 to November 30: rainfall period} of the characteristic sections. Furthermore, the contribution amount calculation unit 16 of the physical model outputs a mapping table {snow accumulation period: [0.5, 0.1]; snow melting period: [0.2, 0.9], rainfall period: [0.9, 0.0]} of the characteristic sections of the contribution amount for each period for each characteristic section. Here, the contribution amount [a, b] is a contribution amount a of the tank model and a contribution amount b of the snow melting model. The physical model data of the tank model includes a height (L1, L2, L3) of an outflow hole, an outflow coefficient (α1, α2, α3, α4), and a permeation coefficient (β1, β2, β3). The physical model data of the snow melting model is digital elevation model data, an air temperature decreasing rate, and an air temperature snow melting rate.

The tank model and the snow melting model calculate respective outflow amounts. The first forecasting residual amount calculation unit 10 calculates a forecasting residual amount of the physical model as follows.

Forecasting residual amount of physical model=river flow rate−cₜ×outflow amount ₜ−cₛ×outflow amount ₛ (8)

Here, cₜ and the outflow amount ₜ are a contribution amount of the tank model and an outflow amount by the tank model, and cₛ and the outflow amount ₛ are a contribution amount of the snow melting model and an outflow amount by the snow melting model. Thereafter, the forecasting model construction unit 11 constructs a forecasting model of the forecasting residual amount of the physical model by machine learning, stores the forecasting model in the forecasting model storage unit 12, and ends the processing.

### Fourth Specific Example

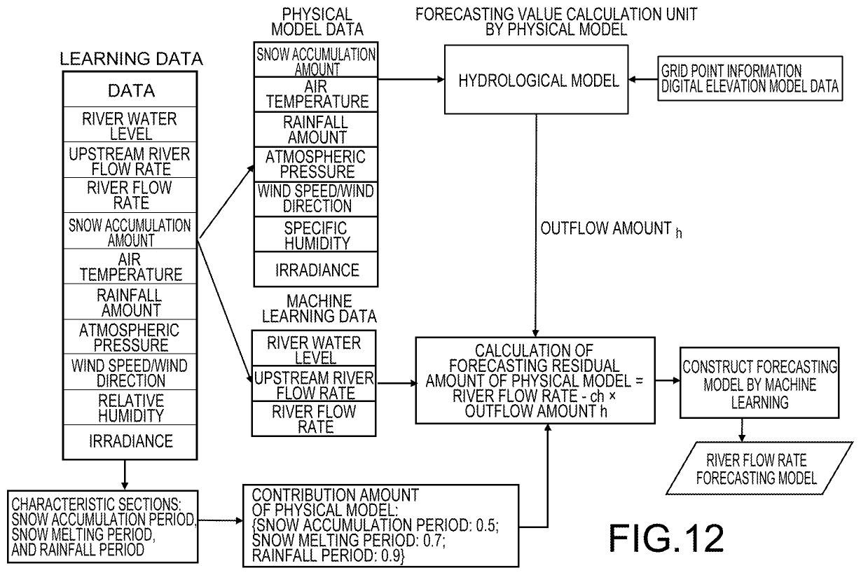

FIG. 12 is a diagram for explaining construction of a forecasting model for predicting a river flow rate or a river water level according to a fourth specific example. FIG. 12 is a modification of FIG. 11. In the fourth specific example, as a physical model, a hydrological model tool, for example, WRF-Hydro® Modeling System, Soil & Water Assessment Tool (SWAT), Hydrological Simulation Program-Fortran (HSPF), and the like can be used instead of a tank model and a snow melting model.

In the example of the river flow rate forecasting, learning data includes a river water level, an upstream river flow rate, a river flow rate, a snow accumulation amount, an air temperature, a rainfall amount, an atmospheric pressure, a wind speed/wind direction, a relative humidity, and an irradiance. The first data division unit 5 divides the snow accumulation amount, the air temperature, the rainfall amount, the atmospheric pressure, the wind speed/wind direction, the relative humidity, and the irradiance of the learning data into physical model data, and divides the river water level, the upstream river flow rate, and the river flow rate into machine learning data. Grid point information and digital elevation model data are used as the physical model data. The characteristic section division unit 15 divides a forecasting period into a snow accumulation period, a snow melting period, and a rainfall period, and outputs a mapping table {December 1 to March 15: snow accumulation period, March 16 to May 31: snow melting period, June 1 to November 30: rainfall period} of the characteristic sections. Furthermore, the contribution amount calculation unit 16 of the physical model outputs a mapping table {snow accumulation period: 0.5; snow melting period: 0.2, rainfall period: 0.9} of the characteristic sections of the contribution amount for each period for each characteristic section. The hydrological model calculates an outflow amount. The first forecasting residual amount calculation unit 10 calculates a forecasting residual amount of the physical model as follows.

Forecasting residual amount of physical model=river flow rate−cₕ×outflow amount ₕ (9)

Here, cₕ and the outflow amount ₕ are a contribution amount of the hydrological model and an outflow amount. Thereafter, the forecasting model construction unit 11 constructs a forecasting model of the forecasting residual amount of the physical model by machine learning, stores the forecasting model in the forecasting model storage unit 12, and ends the processing.

### Fifth Specific Example

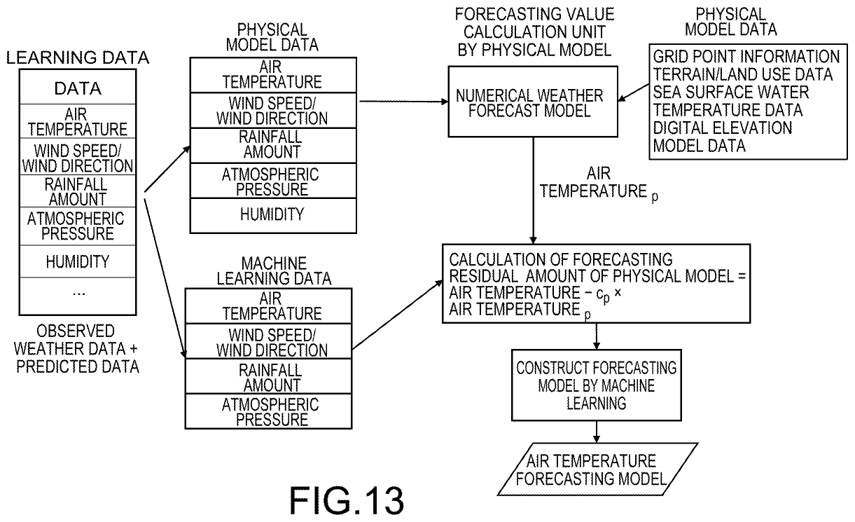

FIG. 13 is a diagram for explaining construction of a forecasting model for weather forecasting according to a fifth specific example. In the fifth specific example, a numerical weather forecast model, for example, a Local Forecast Model (LFM), a MesoScale Model (MSM), a Mesoscale Ensemble Prediction System (MEPS), a Global Spectral Model (GSM), a Global Ensemble. Prediction System (GEPS), a global forecasting system (GFS), a weather research and forecasting (WRF) model, or a computational fluid dynamics (CFD) tool is used as the physical model.

In the fifth specific example, learning data includes an air temperature, a wind speed/wind direction, a rainfall amount, an atmospheric pressure, humidity, and the like which are observed weather data and forecasted weather data. In the fifth specific example, the air temperature is a forecasting target, and the air temperature, the wind speed/wind direction, the rainfall amount, the atmospheric pressure, and the humidity are divided into physical model data, and the air temperature, the wind speed/wind direction, the atmospheric pressure, and the rainfall amount are divided into machine learning data. The grid point information, terrain/land use data, sea surface water temperature data, and digital elevation model data are used as the physical model data. The forecasting residual amount of the physical model is calculated as follows.

Forecasting residual amount of physical model=air temperature−cₚ×air temperature p (10)

cₚ and the air temperature p are a contribution amount of the numerical forecast model and an air temperature calculated by the numerical forecast model. Thereafter, the forecasting model construction unit 11 constructs a forecasting model of the forecasting residual amount of the physical model by machine learning, stores the forecasting model in the forecasting model storage unit 12, and ends the processing.

As described above, in the present embodiment, since the target variable is forecasted by constructing the forecasting model in which the physical model and the machine learning model are fused, the target variable can be forecasted with a high accuracy even when both the time-series data and the control data are included in the explanatory variable and even when the target variable greatly varies with time.

At least a part of the information processing apparatus 1 described in the above-described embodiment may be configured by hardware or software. In a case where the information processing apparatus 1 is configured by software, a program for implementing at least some functions of the information processing apparatus 1 may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk apparatus or a memory.

In addition, a program for implementing at least some functions of the information processing apparatus 1 may be distributed via a communication line (including wireless communication) such as the Internet. Further, the program may be distributed via a wired line or a wireless line such as the Internet or stored in a recording medium in an encrypted, modulated, or compressed state.

The above-described embodiments may be configured as follows.

(1) An information processing apparatus comprising processing circuitry, the processing circuitry configured to:
input first learning data including time-series data to a first model and calculate a forecasting value of a target variable that is a forecasting target;
calculate a first forecasting residual amount that is a deviation of the forecasting value by using second learning data; and
construct a second model for predicting the first forecasting residual amount by machine learning based on the second learning data and the first forecasting residual amount.

(2) The information processing apparatus according to (1), wherein the processing circuitry is further configured to:
select one or two or more first models from a plurality of the first models, wherein
the first learning data is input to the selected one or two or more first models to calculate the forecasting value of the target variable.

(3) The information processing apparatus according to (2), wherein
when two or more first models is selected, the forecasting value of the target variable is calculated based on the first learning data corresponding to each of the two or more first models, and
the first forecasting residual amount is calculated based on the forecasting value calculated by each of the two or more first models.

(4) The information processing apparatus according to (3), wherein
the processing circuitry is further configured to:
calculate a contribution amount with respect to the forecasting value for each of the two or more first models, wherein
the first forecasting residual amount is calculated based on a target variable included in the second learning data and a value obtained by multiplying the contribution amount corresponding to the forecasting value calculated by each of the two or more first models.

(5) The information processing apparatus according to (4), wherein
the first forecasting residual amount is calculated by subtracting each value obtained by multiplying the contribution amount corresponding to the forecasting value calculated by each of the two or more first models from the target variable included in the second learning data.

(6) The information processing apparatus according to (4), wherein
the time-series data is divided into a plurality of characteristic sections for each of the two or more first models, and a contribution amount of the first model is calculated for each of the characteristic sections, and
the first forecasting residual amount is calculated for each of the two or more first models based on the contribution amount of the first model for each of the characteristic sections.

(7) The information processing apparatus according to (6), wherein
a correlation coefficient is calculated between the forecasting value calculated by the first model and the target variable for each of the characteristic sections, and the contribution amount is calculated based on the calculated correlation coefficient.

(8) The information processing apparatus according to (7), wherein
the contribution amount is increased as the correlation coefficient increases.

(9) The information processing apparatus according to any one of (3) to (8), wherein
the processing circuitry is further configured to:
perform a model learning process including inputting the first learning data, calculating the first forecasting residual amount, and constructing the second model; and
predict the target variable based on the learned second model.

(10) The information processing apparatus according to (9), wherein
the processing circuitry is further configured to:
input first forecasting data corresponding to the first learning data to the first model and calculates a forecasting value of the target variable by the first model;
input second forecasting data corresponding to the second learning data to the second model and calculates, by the second model, a second forecasting residual amount that is a deviation between the target variable and the calculated forecasting value; and
predict the target variable based on the calculated forecasting value and the calculated second forecasting residual amount.

(11) The information processing apparatus according to (10), wherein
when the two or more first models are selected, the forecasting value of the target variable is calculated based on the first forecasting data corresponding to each of the two or more first models.

(12) The information processing apparatus according to (11), wherein
the processing circuitry is further configured to:
identify the first forecasting data into a plurality of characteristic sections; and
extract a contribution amount of the first model for each of the plurality of characteristic sections, wherein
the target variable is forecasted for each of the two or more first models based on the contribution amount of the first model for each of the characteristic sections.

(13). The information processing apparatus according to any one of (10) to (12), wherein
the target variable is a dam inflow amount,
a tank model and a snow melting model are selected as the first model, and
a dam outflow amount of the tank model and a dam outflow amount of the snow melting model are calculated.

(14) The information processing apparatus according to any one of (10) to (12), wherein
the target variable is a wind power generation amount,
the first model is a power generation model of a wind turbine, and
a power generation amount of the power generation model of the wind turbine is calculated based on a wind speed and a power generation curve.

(15) The information processing apparatus according to any one of (10) to (12), wherein
the target variable is a river flow rate,
the first model is a hydrological model, and
an outflow amount of the hydrological model is calculated.

(16) The information processing apparatus according to any one of (10) to (12), wherein
the target variable is weather data,
weather research and forecasting (WRF) model and a computational fluid dynamics (CFD) model are selected as the first model, and
weather data of the WRF model and weather data of the CFD model are calculated.

(17) The information processing apparatus according to any one of (1) to (16), wherein
the processing circuitry is further configured to:
divide the learning data into the first learning data and the second learning data;
store the divided first learning data; and
store the divided second learning data, wherein
the forecasting value of the target variable is calculated based on the stored first learning data,
the first forecasting residual amount is calculated by using the stored second learning data, and
the second model is constructed by machine learning based on the stored second learning data and the first forecasting residual amount.

(18) An information processing method for causing a computer to execute:
inputting first learning data including time-series data to a first model and calculating a forecasting value of a target variable that is a forecasting target;
calculating a first forecasting residual amount that is a deviation of the forecasting value by using second learning data; and
constructing a second model for predicting the first forecasting residual amount by machine learning based on the second learning data and the first forecasting residual amount.

(19) The information processing method according to (18), wherein
one or two or more first models is selected from a plurality of the first models, and
the first learning data is input to the selected one or two or more first models to calculate the forecasting value of the target variable.

(20) A non-transitory computer readable recording medium storing a program for causing a computer to execute:
inputting first learning data including time-series data to a first model, and calculating a forecasting value of a target variable that is a forecasting target;
calculating a first forecasting residual amount that is a deviation of the forecasting value by using second learning data; and constructing a second model that predicts the first forecasting residual amount by machine learning based on the second learning data and the first forecasting residual amount.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing apparatus comprising processing circuitry, the processing circuitry configured to:
input first learning data including time-series data to a first model and calculate a forecasting value of a target variable that is a forecasting target;
calculate a first forecasting residual amount that is a deviation of the forecasting value by using second learning data; and
construct a second model for predicting the first forecasting residual amount by machine learning based on the second learning data and the first forecasting residual amount.

2. The information processing apparatus according to claim 1, wherein
the processing circuitry is further configured to:
select one or two or more first models from a plurality of the first models, wherein
the first learning data is input to the selected one or two or more first models to calculate the forecasting value of the target variable.

3. The information processing apparatus according to claim 2, wherein
when two or more first models is selected, the forecasting value of the target variable is calculated based on the first learning data corresponding to each of the two or more first models, and
the first forecasting residual amount is calculated based on the forecasting value calculated by each of the two or more first models.

4. The information processing apparatus according to claim 3, wherein
the processing circuitry is further configured to:
calculate a contribution amount with respect to the forecasting value for each of the two or more first models, wherein
the first forecasting residual amount is calculated based on a target variable included in the second learning data and a value obtained by multiplying the contribution amount corresponding to the forecasting value calculated by each of the two or more first models.

5. The information processing apparatus according to claim 4, wherein
the first forecasting residual amount is calculated by subtracting each value obtained by multiplying the contribution amount corresponding to the forecasting value calculated by each of the two or more first models from the target variable included in the second learning data.

6. The information processing apparatus according to claim 4, wherein
the time-series data is divided into a plurality of characteristic sections for each of the two or more first models, and a contribution amount of the first model is calculated for each of the characteristic sections, and
the first forecasting residual amount is calculated for each of the two or more first models based on the contribution amount of the first model for each of the characteristic sections.

7. The information processing apparatus according to claim 6, wherein
a correlation coefficient is calculated between the forecasting value calculated by the first model and the target variable for each of the characteristic sections, and the contribution amount is calculated based on the calculated correlation coefficient.

8. The information processing apparatus according to claim 7, wherein
the contribution amount is increased as the correlation coefficient increases.

9. The information processing apparatus according to claim 3, wherein
the processing circuitry is further configured to:
perform a model learning process including inputting the first learning data, calculating the first forecasting residual amount, and constructing the second model; and
predict the target variable based on the learned second model.

10. The information processing apparatus according to claim 9, wherein
the processing circuitry is further configured to:
input first forecasting data corresponding to the first learning data to the first model and calculates a forecasting value of the target variable by the first model;
input second forecasting data corresponding to the second learning data to the second model and calculates, by the second model, a second forecasting residual amount that is a deviation between the target variable and the calculated forecasting value; and
predict the target variable based on the calculated forecasting value and the calculated second forecasting residual amount.

11. The information processing apparatus according to claim 10, wherein
when the two or more first models are selected, the forecasting value of the target variable is calculated based on the first forecasting data corresponding to each of the two or more first models.

12. The information processing apparatus according to claim 11, wherein
the processing circuitry is further configured to:
identify the first forecasting data into a plurality of characteristic sections; and
extract a contribution amount of the first model for each of the plurality of characteristic sections, wherein
the target variable is forecasted for each of the two or more first models based on the contribution amount of the first model for each of the characteristic sections.

13. The information processing apparatus according to claim 10, wherein
the target variable is a dam inflow amount,
a tank model and a snow melting model are selected as the first model, and
a dam outflow amount of the tank model and a dam outflow amount of the snow melting model are calculated.

14. The information processing apparatus according to claim 10, wherein
the target variable is a wind power generation amount,
the first model is a power generation model of a wind turbine, and
a power generation amount of the power generation model of the wind turbine is calculated based on a wind speed and a power generation curve.

15. The information processing apparatus according to claim 10, wherein
the target variable is a river flow rate,
the first model is a hydrological model, and
an outflow amount of the hydrological model is calculated.

16. The information processing apparatus according to claim 10, wherein
the target variable is weather data,
weather research and forecasting (WRF) model and a computational fluid dynamics (CFD) model are selected as the first model, and
weather data of the WRF model and weather data of the CFD model are calculated.

17. The information processing apparatus according to claim 11, wherein
the processing circuitry is further configured to:
divide the learning data into the first learning data and the second learning data;
store the divided first learning data; and
store the divided second learning data, wherein
the forecasting value of the target variable is calculated based on the stored first learning data,
the first forecasting residual amount is calculated by using the stored second learning data, and
the second model is constructed by machine learning based on the stored second learning data and the first forecasting residual amount.

18. An information processing method for causing a computer to execute:
inputting first learning data including time-series data to a first model and calculating a forecasting value of a target variable that is a forecasting target;
calculating a first forecasting residual amount that is a deviation of the forecasting value by using second learning data; and
constructing a second model for predicting the first forecasting residual amount by machine learning based on the second learning data and the first forecasting residual amount.

19. The information processing method according to claim 18, wherein
one or two or more first models is selected from a plurality of the first models, and
the first learning data is input to the selected one or two or more first models to calculate the forecasting value of the target variable.

20. A non-transitory computer readable recording medium storing a program for causing a computer to execute:
inputting first learning data including time-series data to a first model, and calculating a forecasting value of a target variable that is a forecasting target;
calculating a first forecasting residual amount that is a deviation of the forecasting value by using second learning data; and
constructing a second model that predicts the first forecasting residual amount by machine learning based on the second learning data and the first forecasting residual amount.
